(19) United States
(12) Patent Application Publication
(10) Pub. No.: US 2022/0375320 A1
(43) Pub. Date: Nov. 24, 2022

(54) Systems And Methods For Managing Information Associated With Storage Containers

(71) Applicant: Wide Afternoon, LLC, Chicago, IL (US)

(72) Inventors: Ty Thompson, Chicago, IL (US); David Joseph, St. Charles, IL (US)

(73) Assignee: Wide Afternoon, LLC, Chicago, IL (US)

(21) Appl. No.: 17/863,379

(22) Filed: Jul. 12, 2022

Related U.S. Application Data
(63) Continuation-in-part of application No. 14/952,386, filed on Nov. 25, 2015, now Pat. No. 11,392,882.
(60) Provisional application No. 62/087,482, filed on Dec. 4, 2014.

(51) Int. Cl. G08B 21/02

(52) U.S. Cl. CPC G08B 21/02

(57) ABSTRACT

Systems and methods are disclosed for managing information associated with storage containers. In accordance with some embodiments, a wireless tracking module includes a communications interface, a timer, and an indicator. The communications interface may receive instructions to track spoilage status of a perishable stored in a storage container and the timer may track a time duration associated with spoilage status of the perishable based on the received instructions. An indication may be provided by the indicator that reflects the spoilage status based on the time remaining in the tracked time duration. Further disclosed embodiments include a storage container including a wireless tracking module. Other embodiments disclose a tracking device that communicates with the wireless tracking module anti includes a timer controller, a communications interface, and an alarm.

### CROSS-REFERENCE TO RELATED APPLICATIONS

This application is a continuation-in-part of U.S. Utility patent application Ser. No. 14/952,386, filed Nov. 25, 2015, entitled “SYSTEMS AND METHODS FOR MANAGING INFORMATION ASSOCIATED WITH STORAGE CONTAINERS,” which claims the benefit of U.S. Provisional Patent Application No. 62/087,482, filed Dec. 4, 2014, entitled “SYSTEMS AND METHODS FOR MANAGING INFORMATION ASSOCIATED WITH STORAGE CONTAINERS,” which are incorporated by reference herein in their entirety.

### BACKGROUND OF THE INVENTION

### 1. Field of the Invention

The present disclosure generally relates to storage containers used for storing and preserving food and other perishables. Specifically, the present disclosure relates to systems and methods for sensing and managing information associated with storage containers.

### 2. Description of Related Art

Storage containers may be used to preserve food and other perishables, sort and organize food supplies, and delay the onset of spoilage. Food can be partitioned into multiple storage containers for the convenience of the user, such as a consumer or a commercial entity, including a restaurant, food producer, wholesaler, or distributor. For example, a user may purchase food in single-serve containers so that the entire contents can be consumed in one sitting. As another example, a user may use storage containers to store and preserve food that is left over from one or more meals. In still another example, commercial food producers can store, organize, and track food shipments and supplies. Further, storage containers can be used in conjunction with refrigeration to increase the effectiveness of spoilage prevention.

Current systems and methods of storage, however, do not provide a user with the ability to track the spoilage status of food or perishable contents in a storage container. Moreover, current systems and methods of storage do not provide a user with any indication of whether food or perishable contents in a storage container are still safe to consume or have spoiled and should be discarded. Further still, current systems and methods of storage do not provide a user with a wireless system for maintaining and tracking a database of storage containers without actually checking the contents, visually or otherwise.

The present disclosure addresses these shortcomings by providing a means to store, track, and coordinate food or perishable supplies, relay spoliation data in real time, eliminate the need for visual and other types of inspection, and generally improve food safety and preservation efforts.

### BRIEF SUMMARY OF THE INVENTION

The present disclosure relates to embodiments for tracking food contents stored in storage containers. Moreover, embodiments of the present disclosure include systems, methods, and computer-readable media managing information associated with food storage containers. As will be appreciated, embodiments of the present disclosure may be implemented with any combination of hardware, software, and/or firmware, including computerized systems and methods embodied with processors or processing components.

In one disclosed embodiment, a system for managing information associated with a storage container includes a storage container and a wireless tracking module included in the container. The wireless tracking module includes a communications interface, a timer, and an indicator. The communications interface may receive instructions to track spoilage status of a perishable stored in the storage container and the timer may track a time duration associated with spoilage status of the perishable based on the received instructions. An end time of the time duration may correspond to a time at which the perishable is expected to be spoiled. The indicator may provide an indication of the spoilage status based on the time remaining in the tracked time duration.

In another disclosed embodiment, a wireless tracking module for managing information associated with a storage container includes a communications interface, a timer, and an indicator. The communications interface may receive instructions to track spoilage status of a perishable stored in a storage container, the storage container being associated with the wireless tracking module. The timer may track a time duration associated with spoilage status of the perishable based on the received instructions. An end time of the time duration may correspond to a time at which the perishable is expected to be spoiled. The indicator may provide an indication of the spoilage status based on the time remaining in the tracked time duration.

In still another disclosed embodiment, a tracking device for managing information associated with a storage container includes a timer controller, a communications interface, and an alarm. The timer controller may receive input corresponding to selection of a time duration for tracking spoilage status of a perishable stored in a storage container, the storage container being associated with a wireless tracking module. The communications interface may provide instructions to the wireless tracking module to track the spoilage status of the perishable based on the time duration. An end time of the time duration may correspond to a time at which the perishable is expected to be spoiled. The alarm may provide an indication of the spoilage status of the perishable based on time remaining in the time duration tracked by the wireless tracking module.

It is to be understood that both the foregoing general description and the following detailed description are exemplary and explanatory only, and are not restrictive of the invention, as claimed.

### BRIEF DESCRIPTION OF THE DRAWINGS

The accompanying drawings, which are incorporated in and constitute a part of this specification, illustrate the disclosed embodiments and, together with the description, serve to explain the principles of the disclosed embodiments.

FIG. 1 illustrates an example system for implementing some embodiments and aspects of the present disclosure;

FIG. 2 illustrates a tracking module for implementing some embodiments and aspects of the present disclosure;

FIGS. 3A-3C illustrate an example implementation of devices configured according to some embodiments and aspects of the present disclosure;

FIG. 4 illustrates an example tracking device or system for implementing some embodiments and aspects of the present disclosure;

FIG. 5 depicts a functional block diagram of a system of the present disclosure with virtual off button functionality;

FIG. 6 depicts a functional block diagram of a system of the present disclosure with state change auto functionality;

FIG. 7 depicts a functional block diagram of a system of the present disclosure with share out functionality;

FIG. 8 depicts a functional block diagram of a system of the present disclosure with voice input functionality; and

FIG. 9 depicts a functional block diagram of a system of the present disclosure with voice query functionality.

### DESCRIPTION OF THE PREFERRED EMBODIMENTS

Embodiments of the present disclosure provide improved systems and methods for managing information associated with storage containers. The disclosed embodiments provide real-time monitoring of events and aspects associated with contents stored in one or more storage containers. According to the embodiments, a tracking module may include one or more sensors and/or a timer capable of sensing and collecting data and events associated with storage container contents, as well as aspects of the surrounding environment. The tracking module can track, for example, spoilage status of food or perishable contents with minimal user input. The tracking module may also include one or more indicators that provide easy identification of spoilage status to the user.

The disclosed embodiments also provide a tracking device that conveniently maintains a database of tracked containers and the statuses associated with their contents. The tracking module may transmit the sensed and collected data to the tracking device for display to the user. Users are able to use the tracking device to customize aspects of the tracking module and transmit commands to the tracking module over a wired or wireless network. The commands may provide an indication to the user of a specific container and the spoilage status associated with contents stored in the container.

Accordingly, the improved systems and methods disclosed herein provide users with the ability to automate and streamline tracking of inventory including food, perishable items, and/or ingredients used at home or in a business. For example, the improved systems and methods disclosed herein may improve operating efficiency by providing real-time indications of spoilage status, thereby alerting a business that inventory should be used immediately or discarded and restocked. Moreover, the improved systems and methods disclosed herein may minimize a consumer's costs associated with discarding uneaten food by providing indications that food is about to spoil and should be consumed immediately. The improved systems and methods disclosed herein also may improve a consumer's management of grocery shopping lists by providing indications that food, perishable items, and/or ingredients have spoiled and therefore need to be repurchased. Furthermore, the improved systems and methods disclosed herein may improve food safety by indicating to businesses and consumers that food or perishable items may have spoiled and therefore are not safe for consumption.

Reference will now be made in detail to exemplar, embodiments, examples of which are illustrated in the accompanying drawings. Wherever possible, the same reference numbers will be used throughout the drawings to refer to the same or like parts.

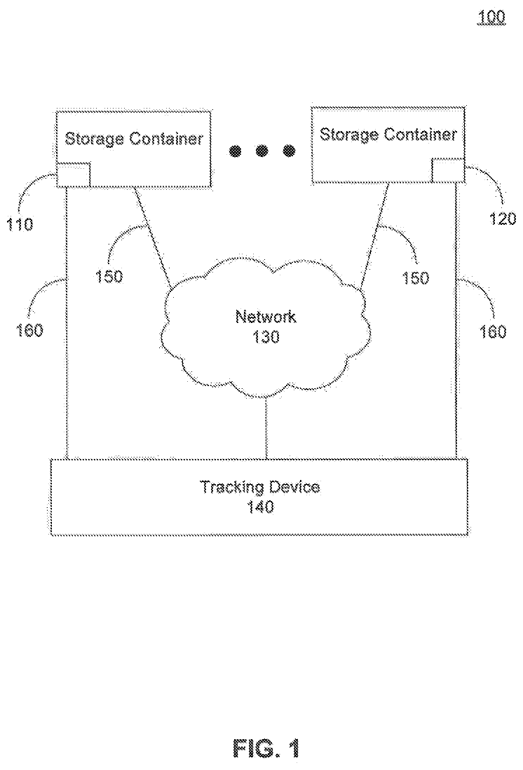

FIG. 1 illustrates a system 100 for managing information associated with storage containers. System 100 may include tracking modules 110 and 120, a tracking device 140, and a network 130. System 100 is an example. The number and distribution of the various entities shown in system 100 may be different depending on specific embodiments. For example, the components in system 100 may be combined and/or distributed over multiple entities, including other computers, handheld computers, mobile phones, tablet computers, or other computing platforms. Thus, the configuration described in system 100 is exemplary only and is not intended to be limiting.

Tracking modules 110 and 120 may be associated with one or more storage containers that contain food contents, including, for example, prepackaged food or food left over from one or more meals. According to some embodiments, food producers, wholesalers. distributors, and/or restaurants may prepackage food contents into one or more storage containers for sale to consumers. For example, food producers may prepackage food contents into one or more storage containers in bulk portions, i.e., a large amount of a single type of food content. Coffee beans, herbs and spices, pre-sliced deli meats (“lunch meat”), nuts, or grains are examples of food contents that may be prepackaged in storage containers in bulk portions. Alternatively, food producers may prepackage food contents into one or more storage containers in single-serve portions, i.e., a portion of food contents generally intended to be consumed by a consumer in one sitting. Yogurt, pre-made sandwiches, and soups are examples of food contents that may be prepackaged in storage containers in single-serve portions.

In some embodiments, users (e.g., food producers, wholesalers, distributors, restaurants, consumers, etc.) may store food contents into one or more storage containers for later consumption. For example, a user may purchase food contents prepackaged in one or more storage containers in bulk portions. The user may partition the bulk food contents into one or more smaller portions and store the smaller portions in one or more storage containers. As another example, a user may prepare a meal that is not fully consumed in one sitting. The user may divide the left over meal into portions and store the portions into one or more storage containers for later consumption.

A user may use tracking device 140 to track various aspects of food contents stored in the storage containers. For example, tracking device 140 may be used to track the type of food contents stored in one or more storage containers located in a refrigeration unit. As another example, tracking device 140 may be used to track the spoilage status of the food contents stored in one or more storage containers. Tracking device 140 may include smartphones, tablets, notebooks, electronic readers, personal digital assistants, personal computers, laptop computers, desktop computers, large display devices, and/or other types of handheld, electronics, or communication devices. Tracking device 140 may also include appliances such as kitchen appliances. For example, tracking device 140 may be a “smart” kitchen appliance such as a refrigeration unit, a freezer unit, or a combination refrigeration/freezer unit. In some embodiments, tracking device 140 may be implemented with hardware devices and/or software applications running thereon.

In some embodiments, tracking device 140 may be configured to communicate through wired or wireless connections 150 to and/or through network 130 with one or more tracking modules such as tracking module 110 and 120 and vice-versa. Network 130 may include any combination of communications networks. For example, network 130 may include the Internet and/or any type of wide area network, an intranet, a metropolitan area network, a local area network (LAN), a wireless network, a cellular communications network, etc. In some embodiments, tracking device 140 may be configured to transmit requests (e.g., requests based on input provided by one or more users) or other data through network 130 to an appropriate tracking module. Tracking device 140 may also be configured to receive information from tracking module 110 and/or 120 through network 130, including data or content sent in response to such requests.

In some embodiments, tracking device 140 may be configured to communicate with one or more tracking modules through one or more peer-to-peer connections 160. Peer-to-peer connections 160 may be implemented using any suitable combination of peer-to-peer communication technologies. For example, peer-to-peer connection 160 may utilize near-field communication (NFC), Wi-Fi Direct, Bluetooth, and/or any other form of peer-to-peer connection. In some embodiments, peer-to-peer connection 160 may comprise a wireless connection. In other embodiments, peer-to-peer connection 160 may include a wired connection.

In some embodiments, tracking modules 110, 120 may sense and manage information associated with one or more storage containers.

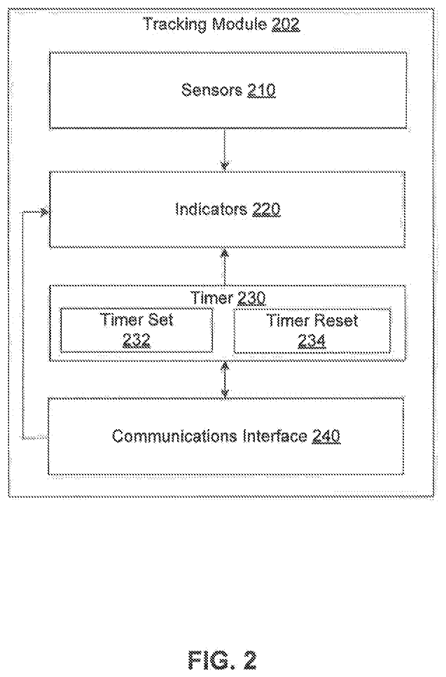

FIG. 2 illustrates an example tracking module 202 for sensing and managing information associated with one or more storage containers. By way of example, tracking module 202 may be used to implement tracking module 110 and/or 120 of FIG. 1. In some embodiments, tracking module 202 may be a standalone device that is capable of being temporarily or permanently affixed to a structure. For example, tracking module 202 may be capable of being temporarily affixed to a lid or a body of a storage container using a clip, adhesive strip, or magnet. In other examples, tracking module 202 may be affixed, to any other structures such as kitchen appliance (e.g., magnetically affixed to a refrigerator door), countertops, or storage racks. In some embodiments, tracking module 202 may be included in a structure. For example, tracking module 202 may be included in a lid or body of a storage container, a kitchen appliance (e.g., integrated into a refrigerator door), a storage rack, etc.

Tracking module 202 may include one or more sensors 210, one or more indicators 220, a timer 230, and a communication interface 240. The arrangement and number of components in tracking module 202 is provided for purposes of illustration. Additional arrangements, number of components, and other modifications may be made, consistent with the present disclosure.

In some embodiments, sensors 213 may include one or mom software and/or hardware components for sensing events or aspects associated with a storage container. For example, sensors 210 may include a photodetector that is configured to detect and constantly measure the amount of light in proximity to a storage container. The photodetector may be implemented as any type of photodetectors known in the art. For example, sensor 210 may be an ambient light sensor that includes a photodiode. In this example, sensor 210 is used to measure light intensity or illuminance (in luminous flux per unit area, or lux) in proximity to a storage container.

As an example implementation of the above, a tracking module 202 that includes a photodetector type of sensor 210 may be located in a refrigeration unit. Sensor 210 may be used to detect changes in light intensity as a result of an event associated with the refrigeration unit. An event may include, for example, a door of the refrigeration unit being opened. As a result, the light intensity proximate to tracking module 202 may increase. Alternatively, or in addition, a light inside of the refrigeration unit may also be illuminated in association with the refrigerator unit's door being opened. Accordingly, sensor 210 may also detect an increase in light intensity as a result of the internal light being illuminated. As another example, an event may include the door of the refrigeration unit being closed and/or the internal light being deactivated. As such, the light intensity proximate to the tracking module 202 may decrease.

In some embodiments, sensors 210 may include one or more software and/or hardware components for sensing and/or detecting events or aspects associated with food or perishables. For example, sensors 210 may include a photodetector that is configured to collect, analyze, and store color histogram data. The photodetector may include, for example, an active-pixel sensor (APS), a charge-coupled device (CCD) sensor, a photodiode, or any other photodetector capable of collecting color histogram data. The photodetector may collect histogram data associated with food or perishables when they are initially stored in a storage container. For example, a user may place food or perishables in a storage container, associate tracking module 202 with the storage container, and activate tracking module 202. Upon activation, tracking module 202 may initially collect, analyze and store color histogram data associated with the food or perishables in a storage container. The photodetector may continue to collect, analyze, and store color data associated with the food or perishables in a storage container while tracking module 202 remains activated.

In some embodiments, analyzing color histogram data associated with food or perishables may include comparing the sensed color histogram data with control data. The control data may include color histograms associated with fresh, degraded, and/or spoiled food or perishables. For example, a user may store broccoli in a storage container. Tracking module 202 may be activated, and the photodetector may collect color histogram data associated with the broccoli. The photodetector may compare the collected color histogram data with color histogram data that represents fresh, degraded, and/or spoiled broccoli. Alternatively, tracking module 202 may transmit the data collected by the photodetector to tracking device 140, and tracking device 140 may compare the collected color histogram data with color histogram data that represents fresh, degraded, and/or spoiled broccoli. Accordingly, the photodetector and/or tracking device 140 are capable of visually monitoring and determining the spoilage status of food or perishables stored in storage containers.

In some embodiments, sensors 210 may include an oxygen sensor and a carbon dioxide sensor. The oxygen and carbon dioxide sensors may be configured to collect, analyze, and store oxygen and carbon dioxide data, respectively, associated with food or perishables in a storage container. For example, the oxygen sensor may be configured to sense the concentration of oxygen gas within the storage container. The carbon dioxide sensor may be configured to sense the concentration of carbon dioxide gas within the storage container. Moreover, the sensors may be configured to determine the spoilage status of the food or perishables in a storage container. For example, broccoli stored in a storage container may consume oxygen and emit carbon dioxide as the broccoli transitions from fresh to spoiled. Accordingly, the sensed oxygen and carbon dioxide concentrations can be monitored and compared with a predetermined threshold indicative of spoilage in order to detect when the broccoli has spoiled. Alternatively, tracking module 202 may transmit the data collected by the oxygen and carbon dioxide sensors to tracking device 140, and tracking device 140 may monitor and compare the concentrations with the predetermined threshold. The predetermined threshold may be specific to a certain type of food or perishable.

In some embodiments, various combinations of sensors 210 may be used to sense and/or detect events or aspects associated with food or perishables stored in a storage container. For example, a photodetector configured to sense and analyze color histogram data may be used in conjunction with oxygen and carbon dioxide sensors to increase the confidence interval of a determination of spoilage status of food or perishables in a storage container.

Timer 230 may be configured to count days, hours and/or minutes which correlate to an expected expiration date for the food contents stored within a storage container. Timer 230 can be manually set to a time duration specified by the user using timer set 232. For example, timer set 232 may be a push button that a user can press to set the time duration. The user may push timer set 232 multiple times, each press corresponding to a predetermined increase in time duration. For example, each press of timer set 232 may correspond to a one minute increase in the specified time duration. Other incremental increases may be used, such as minutes, hours, or days. Once the timer 230 has begun to count down the specified time duration, timer set 232 can be pushed by the user to add additional time to the time duration, thereby increasing the amount of time remaining in the time duration.

Timer reset 234 may be configured to reset the specified time duration back to zero. Timer reset 234 may be implemented as its own push button, or may be implemented as the same push button as timer set 232. In some embodiments, the user may press timer reset 234 to reset the specified time duration back to zero. In some other embodiments, the user may press and hold timer reset 234 for a predetermined time duration to reset the specified time duration back to zero. For example, if the same push button is configured to implement both timer set 232 and timer reset 234, and pressing the push button has already been configured to increase the amount of time in the specified time duration, the user may press and hold timer reset 234 for three seconds (or any other time duration) to reset the specified time duration back to zero.

Indicators 220 may be configured to provide a visual indication to the user associated with the spoilage status of the food contents in a storage container. In some embodiments, indicators 220 may be one or more light emitting diodes (LEDs). Indicators 220 may be implemented as a single LED that flashes intermittently to indicate spoilage status of the food contents in a storage container. For example, an LED indicator 220 may be configured with three different frequencies of intermittent flashes that correlate to various stages of spoilage status (e.g., spoilage is far off, spoilage is imminent, and spoilage has most likely occurred). The various stages of spoilage status may correspond to various time portions of the time duration specified by timer 230. For example, the user may specify a 3-day time duration using timer set 232 of timer 230. Timer 230 may begin to count down the 3-day timer duration. LED indicator 220 may begin with a slow or low frequency intermittent flash, transition to a high frequency intermittent flash the day before the food contents is expected to spoil, and transition to a solid illuminance once the specified time duration has expired.

In some embodiments, indicators 220 may be implemented as a single multicolor LED assembly or multiple LEDs comprising multiple colors. For example, a multicolor LED indicator 220 may be a red/green/yellow LED that changes color to indicate spoilage status of the food contents in a storage container. Multicolor LED indicator 220 may be configured with three different colors that correlate to various stages of spoilage status (e.g., spoilage is far off, spoilage is imminent, and spoilage has most likely occurred). The various stages of spoilage status may correspond to various time portions of the time duration specified by timer 230. For example, the user may specify a 3-day time duration using timer set 232 of timer 230. Timer 230 may begin to count down the 3-day timer duration. Multicolor LED indicator 220 may begin by illuminating as a green color, transition to a yellow color the day before the food contents is expected to spoil, and transition to a red color once the specified time duration has expired.

In some embodiments, indicator 220 may provide a visual indication as the result of an event. For example, sensor 210 may be configured as a photodetector and may detect increases and decreases in light intensity proximate to a storage container. Indicator 220 may be configured to provide a visual indication when the light intensity detected by sensor 210 is greater than a predetermined threshold. Indicator 220 may also be configured to deactivate the visual indication when the light intensity detected by sensor 210 is less than a predetermined threshold. The threshold may be configures as an illuminance value (as measured in lux) associated with a refrigeration unit door being opened or a light internal to the refrigeration unit being illuminated.

Communication interface 240 may be configured to send and receive data and/or instructions from tracking device 140. Communication interface 240 may be implemented as a Wi-Fi interface and may communicate with tracking device 140 through network 130. Alternatively, or in addition to, communication interface 240 may be implemented as a Bluetooth, NFC, or Wi-Fi Direct interface and may communicate with tracking device 140 via peer-to-peer connection 160.

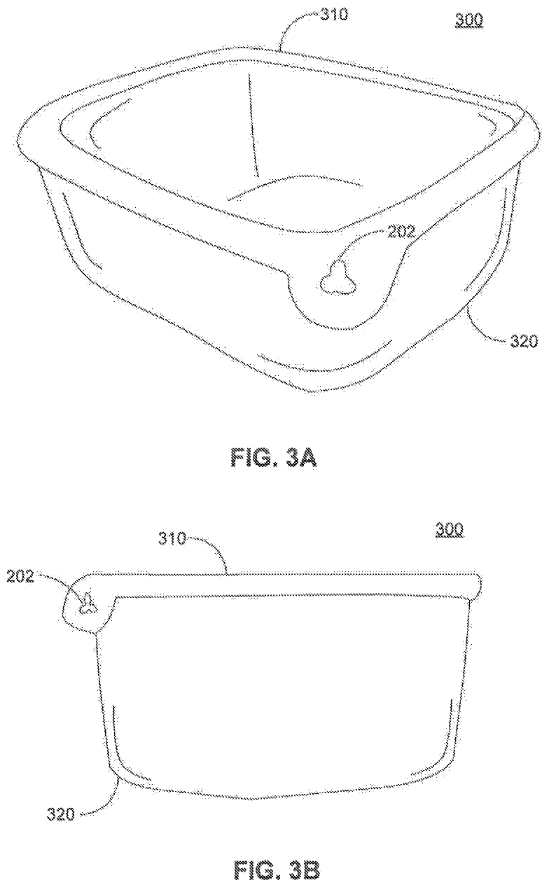

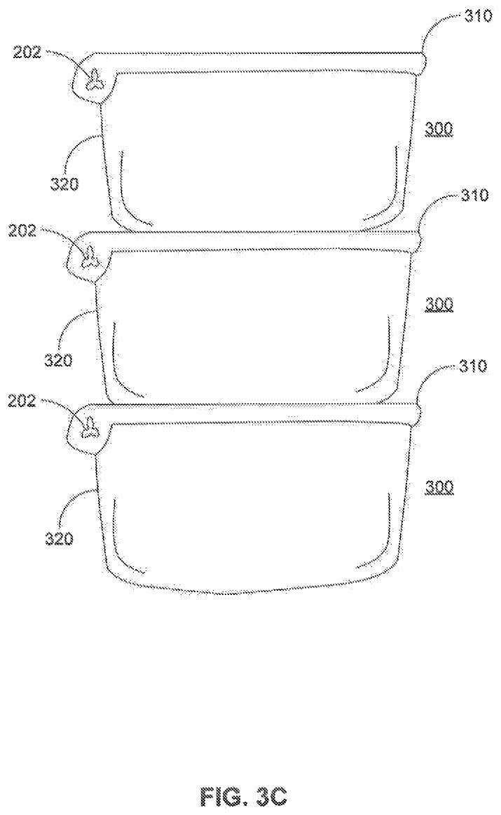

FIGS. 3A-3C illustrate an example implementation of storage container 300. By way of example, storage container 360 may be used to implement the storage containers of FIG. 1. FIGS. 3A and 3B illustrate a perspective view and a side plan view, respectively, of storage container 300 including a tracking module 202. As shown in FIGS. 3A and 3B, storage container 300 may include a lid 310 and a body 320. In some embodiments, lid 310 may be disconnectably connected to body 320. In some other embodiments, lid 310 may be fixed to body 320, for example, along an edge or an end of lid 310 and body 320.

In some embodiments, tracking module 202 may be located on lid 310. For example, tracking module 202 may be included in a protrusion that is located at one of the corners along the perimeter of lid 310. The protrusion may be hermetically sealed to prevent water or humidity ingress and, thus, damage to tracking module 202. In some other embodiments, tracking module 202 may be located at another location along the perimeter of lid 310. In still some other embodiments, tracking module 202 may be located on body 320. Locating tracking module 202 in a protrusion that is located at one of the comers along the perimeter of lid 310 or locating tracking module 202 at another location along the perimeter of lid 310 allows the user an unobstructed view of the food contents in storage container 300. For example, lid 310 may be clear (i.e., transparent or see-through) such that the food contents in storage container 300 can be viewed by the user through lid 310. Locating tracking module 202 at the perimeter of lid 310 prevents tracking module 202 from obstructing the user's view of food contents in storage container 300 through clear lid 310. Further, locating tracking module 202 in a protrusion that is located at one of the comers along the perimeter of lid 310 or locating tracking module 202 at another location along the perimeter of lid 310 allows the user an unobstructed view of the food contents through body 320. For example, in some embodiments body 320 may be clear (i.e., transparent or see-through) such that the food contents in storage container 300 can be viewed by the user through body 320. Locating tracking module 202 at the perimeter of lid 310 prevents tracking module 202 from obstructing the user's view of food contents in storage container 300 through clear body 320.

FIG. 3C illustrates a side plan view of a plurality of storage containers 300. As shown in FIG. 3C, the storage containers 300 may be stackable. For example, each lid 310 and may be configured so a body 320 may rest on top of it. Accordingly, each body 300 may also be configured so that it may rest on top of a lid 310. Locating tracking module 202 in a protrusion that is located at one of the corners along the perimeter of lid 310 or locating tracking module 202 at another location along the perimeter of lid 310 allows for the ability to stack storage containers 300 without obstructing the user's view of tracking module 202. Further, such placement of tracking module 202 allows the user an unobstructed view of the food contents through body 320.

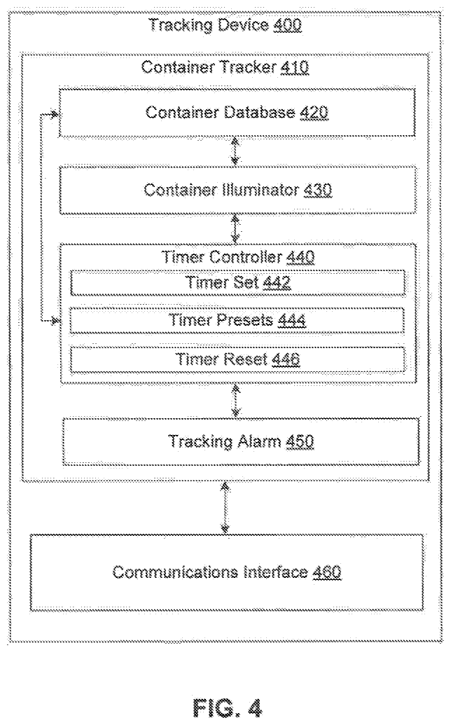

FIG. 4 illustrates an example tracking device 400 according to some embodiments and aspects of the present disclosure. In some embodiments, tracking device 400 may be configured for managing information associated with food storage containers. By way of example, tracking device 400 may be used to implement tracking device 140 of FIG. 1. Tracking device 400 may include a container tracker 410 and a communications interface 460. The arrangement and number of components in tracking device 400 is provided for purposes of illustration. Additional arrangements, number of components, and other modifications may be made, consistent with the present disclosure.

Communication interface 460 may be configured to send and receive data and/or instructions from tracking modules 110 and 120. Communication interface 460 may be implemented as a Wi-Fi interface and may communicate with tracking modules 110 and 120 through network 130. Alternatively, or in addition to, communication interface 460 may be implemented as a Bluetooth, NFC, or Wi-Fi Direct interface and may communicate with tracking modules 110 and 120 via peer-to-peer connection 160.

Container tracker 410 may include a container database 420, a container illuminator 430, a timer controller 440, and a tracking alarm 450. In some embodiments, container database 420, container illuminator 430, timer controller 440, and tracking alarm 450 may be implemented as hardware modules configured to execute the functions described herein. In some other embodiments, a container tracking processor (not shown) may be configured to execute the functions of container database 420, container illuminator 430, timer controller 440, and tracking alarm 450. For example, container tracking processor may communicate with a memory/storage device (not shown) that includes container database 420, container illuminator 430, timer controller 440, and tracking alarm 450 in the form of computer-executable instructions, such that container tracking processor may then execute these instructions. As another example, the functions of container database 420, container illuminator 430, timer controller 440, and tracking alarm 450 may be included in container tracking processor, such that container tracking processor is configured to implement these functions.

In some embodiments, container database 420 may include information associated with one or more storage containers associated with tracking modules 110, 120 that are being tracked by a user. For example container database 420 may include one or more identifiers associated with storage containers that include a timer 230 that has been enabled to track a timer duration specified by the user. Container database 420 may also list the contents of each storage container. For example, the contents may be represented by a visual indicator (e.g., an image of a chicken may be used if the container contains chicken), a descriptor (e.g., the word “Chicken” may be used if the container contains chicken), or any combination thereof. Further, container database 420 may also include for each storage container the time remaining before the time duration associated with that container expires. For example, the time remaining may be represented as a number of days remaining (e.g., 3 Days Remaining), a number of hours and minutes remaining (e.g., 48 Hours 23 Minutes Remaining), or any combination thereof (e.g., 3 Days 2 Hours 14 Minutes Remaining).

In some embodiments, container database 420 may include a qualitative indicator that corresponds to various stages of spoilage status (e.g., spoilage is far off, spoilage is imminent, and spoilage has most likely occurred). The various stages of spoilage status may correspond to various time portions of the time duration specified by a timer 230 of a tracking module 110 or 120. For example, the user may specify a 3-day time duration wherein the qualitative indicator begins as “Fresh”, thereby indicating a low likelihood of spoilage. As the time duration reaches expiration, qualitative indicator may transition to “Nearing Spoilage” the day before the food contents are expected to spoil. The qualitative indicator may transition to “Spoiled” once the specified time duration has expired.

In some embodiments, timer controller 440 may be used to implement some or all of the functions of timer 230. For example, timer controller 440 may be configured to count days, hours and/or minutes which correlate to an expected expiration date for the food contents stored within a storage container. In some other embodiments, timer controller 440 may be used to set and reset the time period tracked by timer 230. In some embodiments, timer controller 440 can be implemented to manually set to a time duration specified by the user using timer set 442. For example, timer set 442 may be a push button or a graphical representation on a touch screen that a user can press to set the time duration. The user may push timer set 442 multiple times, each press corresponding to a predetermined increase in time duration. For example, each press of timer set 442 may correspond to a one minute increase in the specified time duration. Other incremental increases may be used, such as minutes, hours, or days. In some embodiments, timer set 442 may allow a user to enter the desired amount of time using an input such as a physical or touchscreen keyboard. Once the desired time period has been selected by the user, communications interface 460 may transmit instructions to timer 230 of tracking module 110 or 120 to begin tracking the time period. Timer 230 may begin to count down the specified time duration. Timer set 442 can be pushed by the user to add additional time to the time duration, thereby increasing the amount of time remaining in the time duration.

In some embodiments, timer controller 440 may be used to set timer 230 to a specified time duration using timer presets 444. Timer presets 444 may include one or more predetermined time durations associated with various types of food contents. For example, may include predetermined time durations associated with chicken, broccoli, eggs, etc. The predetermined time durations associated with a specific type of food may depend on whether the food is raw or has been cooked. For example, a predetermined time duration associated with raw chicken may be different from a predetermined time duration associated with cooked chicken.

Timer reset 446 may be configured to reset the specified time duration back to zero. Timer reset 446 may be implemented as its own push button (physical or touchscreen based), or may be implemented as the same push button as timer set 442. In some embodiments, the user may press timer reset 446 to reset the specified time duration hack to zero. In some other embodiments, the user may press and hold timer reset 446 for a predetermined time duration to reset the specified time duration back to zero. For example, if the same push button is configured to implement both timer set 442 and timer reset 446, and pressing the push button has already been configured to increase the amount of time in the specified time duration, the user may press and hold timer reset 446 for three seconds (or any other time duration) to reset the specified time duration back to zero.

Tracking alarm 450 may be configured to provide an indication to the user of various stages of food spoilage. For example tracking alarm 450 may be configured to provide the user with an indication that the time duration tracked by timer controller 440 (or timer 230) is about to expire. As an example, tracking alarm 450 may provide the user with an indication that there may be one day remaining in the time duration. The indication may be implemented as a visual cue (e.g., a popup alert or reminder on a display screen of tracking device 400 (not shown)), an audio cue (e.g., a tone or sequence of tones played by tracking device 400), or any combination thereof (e.g., a popup alert in combination with a sequence of tones). The indication, therefore, may alert the user that the contents stored in a storage container is about to spoil and should be consumed immediately. Tracking alarm 450 may also be configured to provide the user with an indication that the time duration has expired. The indication that the time duration has expired may be different from the indication that one day is remaining in the time duration (e.g., different visual/audio cues may be used). The indication, therefore, may alert the user that the contents stored in a storage container has spoiled and should be discarded by the user.

Container illuminator 430 may enable the user to select specific storage containers associated with one or more tracking modules 110, 120, and activate/deactivate their indicators. For example, a user may select a storage container from container database 420. The user may select container illuminator 430, and container illuminator 430 may send instructions to the tracking module 110 associated with the selected storage container through communications interface 460 to active an indicator 220 associated with the selected storage container. If indicator 220 is configured with a multicolor LED indicator, for example, the user may illuminate the multicolor LED indicator 220 by selecting container illuminator 430. The user may select container illuminator 430 again to deactivate multicolor LED indicator 220. Thus, container illuminator 430 allows a user to quickly identify storage container and their contents, as well as the spoilage status of those contents.

It should be noted that the device for tracking spoilage of a perishable item may comprise a food storage container, a food storage container lid, a clip, a tag, a housing, a label, or any structure that may be attached or placed with a perishable item (either on or off of a container). The perishable item may be a food item, but may also be any perishable item, item or material that expires or otherwise warrants tracking for freshness or optimal use. Such items, by way of example and not limitation, include medications and other medical or therapeutic materials, drugs and drug additives and dyes, beverages, cannabis, alcohol, breast milk, baby formula, lotions, ointments, insect repellent, sunscreen, makeup, batteries, smoke detectors, lire extinguishers, fuel, petroleum products, seals and gaskets, safety equipment and safety devices, and the like.

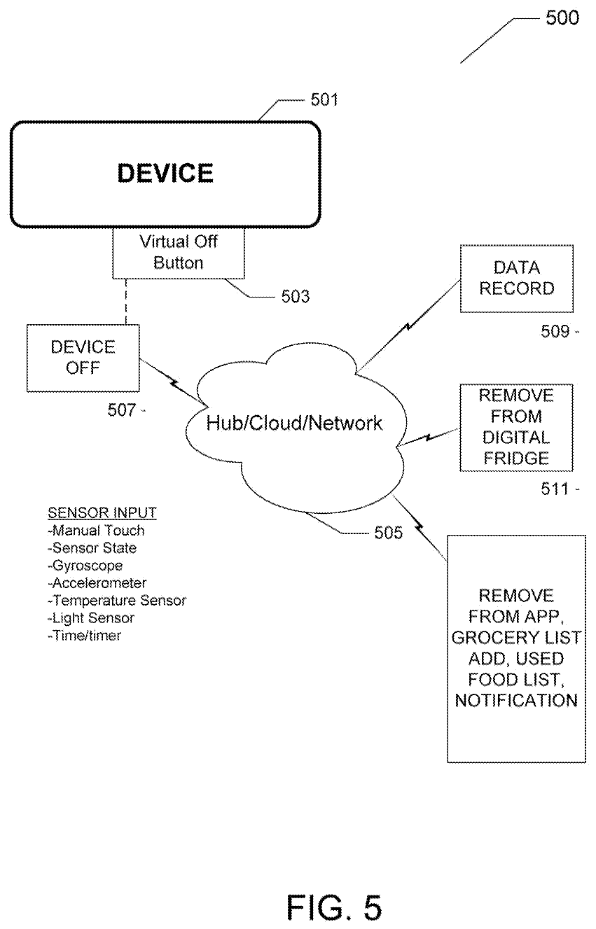

The device of the present invention and related systems and methods may also include additional or enhanced functionality. Several examples of such functionality are provided herein by way of FIGS. 5-9 and the related descriptions herein.

As stated herein, the device for tracking spoilage status of a perishable item comprises a computer having a processor, memory, and access to computer readable media and at least one computer program stored on non-transitory computer readable media. The computer may be a microprocessor, a microcontroller, or the like. The descriptions of FIGS. 5-9 should be considered with such a computer configured to execute the functionality so described.

FIG. 5 depicts a functional block diagram of a system of the present disclosure with virtual off button functionality. The device 501 for tracking spoilage status of a perishable food item in this embodiment comprises a virtual off button 503. The virtual off button 503 provides a state trigger that in turn provides signaling to initiate an event. The virtual off button 503 may be a physical button located on the device that responds to a manual or tactile touch. The virtual off button 503 may also be a change of state of a sensor such as a light sensor, or may, in some embodiments, be a gyroscope, an accelerometer, a temperature sensor, or a timer. The purpose of the virtual off button 503 is to provide a device off indicator 507 to a network, hub or cloud 505 and in turn remove the perishable item from a software application (app) contained on an electronic device, add the perishable item to a grocers list or a used food list, create a notification to replenish the item. The device off event 507 initiates a data record step 509 and also removes the item from a digital fridge 511 (removes the item from a digital record of a perishable item in the location). Activation of the virtual off button 503 thus provides an indication to downstream systems that the user wishes to remove the perishable item associated with that particular device from inventory, tracking or monitoring. The perishable item in this case may be used up, depleted, used completely, spoiled, given away or otherwise unwanted.

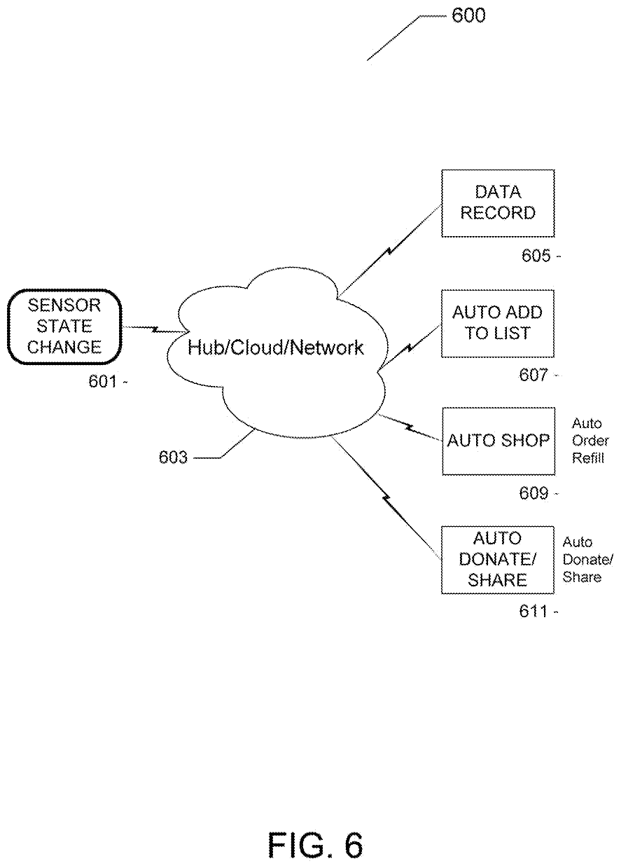

FIG. 6 depicts a functional block diagram of a system of the present disclosure with state change auto functionality. State change or state transition may include temperature transitions, light transitions, date and time transitions, and the like. State changes arc monitored and recorded with a computer having a processor, memory, and access to computer readable media, and may be considered a state machine. When a state change occurs, various actions may result, such as, but not limited to, notifying a user of food to be used, adding to a virtual grocery cart, adding to a grocery list, automatically reordering, suggesting a recipe, providing food use suggestions, saving a recipe, creating a new recipe, entering a recipe, suggesting a device (a tag) be put into action when inactivity is determined, suggesting a refrigerator cleaning when tags have been in the red (item has perished) for a period of time (such as two days), suggesting additional devices (tags) be purchased (making an offer to purchase additional devices (tags)) when all devices (tags) are in use for a period of time, recording and processing trends such as encouraging usage when items are used in a timely manner, suggesting more items are purchased when items are not being used or devices (tags) are not being used, offering nutritional options such as nutritional diversity options based on trends of items consumed, and the like.

When a sensor (such as a light sensor, a temperature sensor, a humidity sensor or the like) changes state in 601, a signal or communication is sent by way of a hub cloud/network 603 and one or more of the following actions are taken based on the description above. Data related to the state change is recorded in 605, an item is auto added to a list in 607, automatic shopping or auto order refill occurs in 609, and/or the item is auto donated or auto shared in 611. Auto donate or auto share occurs when, for example, an items gets close to it's expiration, and a network based message is sent to facilitate donation or sharing of the item such that waste is avoided. In addition to temperature sensors, other sensors may be employed, such as weight sensors, humidity sensors, pressure sensors, accelerometers, gas sensors (such as CO2, methane, ethylene), color or optical sensors, biogenic amine sensors, range sensors (such as laser or acoustic sensors), depth sensors (optical, photonic, acoustic, and the like), gyroscopes, or the like.

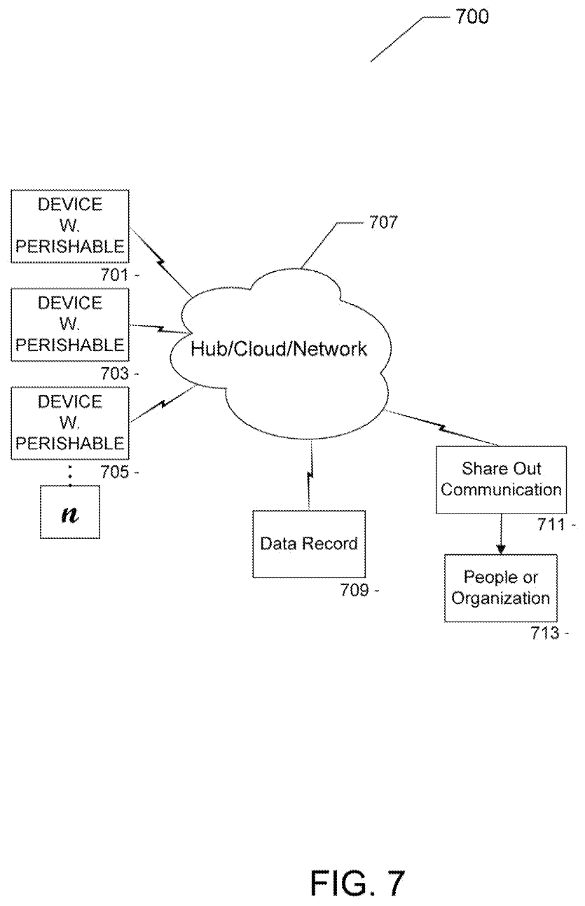

FIG. 7 depicts a functional block diagram of a system of the present disclosure with share out functionality. A share button may also be provided in an app that resides on an electronic device such as a smart phone. When a device (tag) 701, 703, 705 that is associated with a perishable item reaches a state change to indicate that the perishable item is nearing expiration, a message is sent through a hub/cloud/network 707 to record the data associated with the event in 709. Further the message triggers a share out communication 711 to a list of people or an organization(s) that the perishable item is available. A user may define such a list through an app on an electronic device such as a smart phone. The app may also facilitate communication related to the share out communication such as item to be shared, quantity available, meet up location, closeness to expiration, and the like.

It should be noted that individual user databases may be established, and may include food databases, recipes, expiration parameters, recall databases, safety concerns, and the like. A recall database or safety concern database be contain dynamically updated safety data that relates to perishable items contained in a digital storage or virtual refrigerator that may reside at least partly on an app resident on a smart phone.

A database of perishable item data may be connected to, or otherwise associated with, the device and system of the present invention. The perishable item data may include not only the perishable items themselves, but also expiration dates, recipes, dynamic adjustors, nutrition information, purchasing information, as well as perishable item safety or recall information.

In some embodiments of the present invention, a dynamically adjusting database or databases may be employed. The dynamically adjusting database(s) may, for example, adjust expiration dates based on inputs such as location, weather, time, or the like. Further, recipe suggestions may be provided based on, for example, items that are being tracked and may. for example, be contained in the user's digital fridge (provided on an app for example).

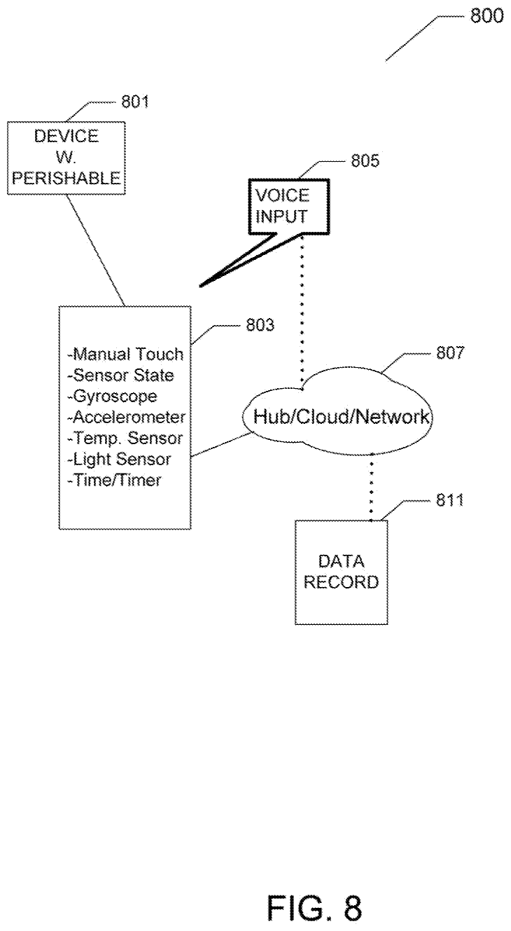

FIG. 8 depicts a functional block diagram of a system of the present disclosure with voice input functionality. Voice commands may be directed to the device (tag) using speech recognition technology and a related hardware module. The voice commands may set a timer on the device (tag), activate LEDs to identify a specific device (tag), activate a speaker or acoustic device to identify a specific device (lag). A device (tag) 801 associated with a perishable item may take input 803 through a variety of means such as manual touch, a sensor state, a gyroscope, an accelerometer, a temperature sensor, a light sensor, a timer, or the like. In addition, in some embodiments of the present invention, the device (tag) 801 may take voice input 805 through a speech recognition module and related software. The voice input is also sent through a network such as a hub/cloud/network 807 where communication may also occur with other connected devices. The hub/cloud/network 807 also facilitates communication between the devices (tags) and an app contained on an electronic device such as a smart phone. A data record 811 is also created of the input to or output from the device associated with the perishable.

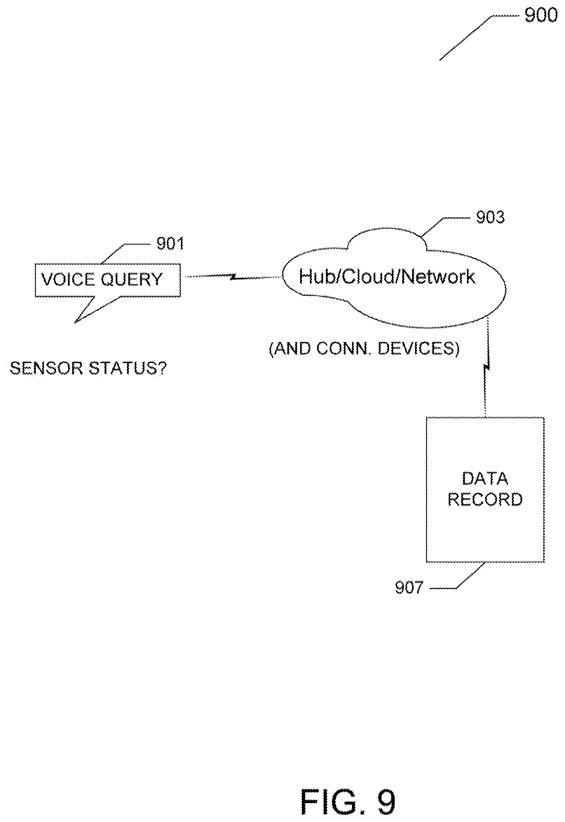

FIG. 9 depicts a functional block diagram of a system of the present disclosure with voice query functionality. A voice query 901 may be directed toward a device (tag) or an app that may include a speech recognition device, and may request, for example, a sensor status for the device (tag). The voice query 901 is then communicated to a hub/cloud/network 903 and any related connected devices. The hub/cloud/network 903 facilitates communication between the devices (tags) and an app contained on an electronic device such as a smart phone. The voice query 901 also initiates the creation of a data record 907.

Certain features which, for clarity, are described in this specification in the context of separate embodiments may also be provided in combination as a single embodiment. Conversely, various features which, for brevity, are described in the context of a single embodiment may also be provided in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

What is claimed is:

1. A device for tracking spoilage status of a perishable item comprising:
a wireless tracking module contained with the food storage container and comprising a communications interface configured to receive instructions and configured to send instructions to track spoilage status of a perishable stored in the storage container;
wherein the received instructions comprise the steps of: set timer, turn on visual display indicator based on ambient light reading, turn off visual display indicator based on ambient light reading, change timer setting, stop timer, activate tracking module, associate tracking module with device, receive information associated with the contents of the food storage container, and reset device; and
wherein the sent instructions comprise the steps of: button press notification, ambient light reading, food is no longer being tracked, and device has been turned off;
a timer configured to count the time remaining before a spoilage event;
a visual display indicator configured to provide a visual indication of food spoilage status as determined by a comparison of counted time on the timer to a food spoilage time for a specified food;
a photodetector operatively coupled to the visual display indicator and configured to deactivate the visual display indicator when light intensity detected by the photodetector is less than a predetermined threshold; and
a virtual off button configured to send instructions to an electronic device.

2. The device of claim 1, wherein the instructions sent from the virtual off button comprise the step of: remove perishable item listing from a software application (app) contained on the electronic device.

3. The device of claim 1, wherein the instructions sent from the virtual off button comprise the step of: provide instructions to replenish the perishable item with a software application (app) contained on the electronic device.

4. The device of claim 1, wherein the instructions sent from the virtual off button comprise the step of: provide instructions to share the perishable item with a software application (app) contained on the electronic device.

5. The device of claim 1, wherein the virtual off button is selected from the group consisting of: a manual touch button, a sensor state, a gyroscope, an accelerometer, a temperature indicator, a time indicator, and a light indicator.

6. The device of claim 1, wherein the electronic device is a hand held electronic device.

7. A device for tracking spoilage status of a perishable item comprising:
a wireless tracking module contained with the food storage container and comprising a communications interface configured to receive instructions and configured to send instructions to track spoilage status of a perishable stored in the storage container;
wherein the received instructions comprise the steps of: set timer, turn on visual display indicator based on ambient light reading, turn off visual display indicator based on ambient light reading, change timer setting, stop timer, activate tracking module, associate tracking module with device, receive information associated with the contents of the food storage container, and reset device; and
wherein the sent instructions comprise the steps of: button press notification, ambient light reading, food is no longer being tracked, and device has been turned off;
a timer configured to count the time remaining before a spoilage event;
a visual display indicator configured to provide a visual indication of food spoilage status as determined by a comparison of counted time on the timer to a food spoilage time for a specified food;
a photodetector operatively coupled to the visual display indicator and configured to deactivate the visual display indicator when light intensity detected by the photodetector is less than a predetermined threshold; and
a state machine configured to send instructions to an electronic device.

8. The device of claim 7, wherein the instructions sent from the state machine comprise the step of: notify a user of a food to be used with a software application (app) contained on the electronic device.

9. The device of claim 7, wherein the instructions sent from the state machine comprise the step of: notify a user of a food to be added to a grocery cart list with a software application (app) contained on the electronic device.

10. The device of claim 7, wherein the instructions sent from the state machine comprise the step of: suggest nutritional options to a user with a software application (app) contained on the electronic device.

11. The device of claim 7, wherein the instructions sent from the state machine comprise the step of: provide an offer to purchase more devices with a software application (app) contained on the electronic device.

12. The device of claim 7, wherein the instructions sent from the state machine comprise the step of: provide food usage suggestions with a software application (app) contained on the electronic device.

13. The device of claim 7, further comprising a speech recognition device.

14. The device of claim 13, wherein the speech recognition device is configured to provide user commands to a software application (app) contained on the electronic device.

15. The device of claim 7, wherein the electronic device is a hand held electronic device.

16. A device for tracking spoilage status of a perishable item comprising:
a wireless tracking module contained with the food storage container and comprising a communications interface configured to receive instructions and configured to send instructions to track spoilage status of a perishable stored in the storage container;
wherein the received instructions comprise the steps of: set timer, turn on visual display indicator based on ambient light reading, turn off visual display indicator based on ambient light reading, change timer setting, stop timer, activate tracking module, associate tracking module with device, receive information associated with the contents of the food storage container, and reset device; and
wherein the sent instructions comprise the steps of: button press notification, ambient light reading, food is no longer being tracked, and device has been turned off;
a timer configured to count the time remaining before a spoilage event;
a visual display indicator configured to provide a visual indication of food spoilage status as determined by a comparison of counted time on the timer to a food spoilage time for a specified food;
a photodetector operatively coupled to the visual display indicator and configured to deactivate the visual display indicator when light intensity detected by the photodetector is less than a predetermined threshold; and
a connection to a database of perishable item data.

17. The device of claim 16, wherein the perishable item data comprises expiration dates.

18. The device of claim 16, wherein the perishable item data comprises recipes.

19. The device of claim 16, wherein the perishable item data comprises dynamic adjusters.

20. The device of claim 16, wherein the perishable item data comprises nutrition information.

21. The device of claim 16, wherein the perishable item data comprises perishable item safety or recall information.
